(19) United States
(12) Patent Application Publication
(10) Pub. No.: US 2013/0135306 A1
(43) Pub. Date: May 30, 2013

(54) METHOD AND DEVICE FOR EFFICIENTLY EDITING A THREE-DIMENSIONAL VOLUME USING RAY CASTING

(71) Applicant: Klaus Engel, Nurnberg (DE)

(72) Inventor: Klaus Engel, Nurnberg (DE)

(21) Appl. No.: 13/485,910

(22) Filed: May 31, 2012

(30) Foreign Application Priority Data
Jun. 1, 2011 (DE) 10 2011 076 878.5

(51) Int. Cl. G06T 15/06

(52) U.S. Cl. CPC G06T 15/06
USPC 345/423

(57) ABSTRACT

A method for efficiently changing a depiction of a three-dimensional volume using ray casting is providing. The method includes dividing the three-dimensional volume into zones, inputting a change that is required to the depiction, and ascertaining the zones that are affected by the change. The method also includes classifying the change as relevant to a zone when the zone is affected by the change and effecting an assignment between the affected zones and the relevant changes. The method includes performing ray casting using simulated rays. A change is only carried out for sampling points along the rays when the sampling point lies in an affected zone.

This application claims the benefit of DE 10 2011 076 878.5, filed on Jun. 1, 2011.

### BACKGROUND

The present embodiments relate to a method and a device for efficiently changing the depiction of a three-dimensional volume using ray casting.

Volume rendering includes the depiction or visualization of three-dimensional bodies or objects. The modeling, reconstruction or visualization of three-dimensional objects has a broad range of applications in the fields of medicine (e.g., CT, PET, MR, ultrasound), physics (e.g., electron structure of large molecules) or geophysics (e.g., nature and position of earth layers). The object under examination may be irradiated (e.g., using electromagnetic waves or sonic waves) in order to examine the nature of the object. The scattered radiation is detected, and properties of the object are determined from the detected values. The result may include a physical variable (e.g., density, tissue component content, elasticity, speed) having a value determined for the object. A virtual grid may be used in this case, the value of the variable being determined at the grid points of the virtual grid. The grid points, or the values of the variables at the grid points, may be referred to as voxels. The voxels may be present in the form of tonal values.

Volume rendering makes use of the voxels to generate a three-dimensional depiction of the examined object or body on a two-dimensional depiction surface (e.g., display screen). Pixels are generated from the voxels (e.g., via the intermediary stage of object points that are obtained from the voxels using interpolation). The image of the two-dimensional image display is composed of the pixels. In order to visualize three dimensions on a two-dimensional display, alpha blending (or alpha decomposition) may be performed. Using this standard method, voxels or volume points formed from voxels are assigned both colors and transparency values (e.g., values for the non-permeability or opacity (expressing the transparency or the covering power of various layers of the body)). More specifically, an object point may be assigned three colors in the form of a three-tuple, which encodes the portions of the colors red, green and blue (e.g., RGB value), and an alpha value, which parameterizes the opacity. These variables together form a color value RGBA that is combined or mixed with the color values of other object points to form a color value for the pixel (e.g., using alpha blending for the visualization of partially transparent objects).

A suitable color value may be assigned using an illumination model. The illumination model takes light effects (e.g., reflections of the light on surfaces of the object, including the outer surface or surfaces of inner layers of the examined object) into consideration in a modeled or simulated irradiation of the object for the purpose of the visualization.

The references describe a range of illumination models that are used. For example, the Phong or Blinn-Phong model is commonly used.

One of the most commonly used methods for volume rendering is ray casting or the simulation of light irradiation for the purpose of depicting or visualizing the body.

In the context of ray casting, imaginary rays coming from the eye of an imaginary observer are transmitted through the examined body or object. RGBA values for sampling points are ascertained from the voxels along the rays and merged to form pixels for a two-dimensional image using alpha compositing or alpha blending. In this case, illumination effects may be taken into consideration using one of the above cited illumination models as part of a method known as “shading.”

In order to more effectively study the properties of an object that is depicted using volume rendering, the depiction of the object may be adapted. Specifically, the depiction of the object, as depicted on a display screen, may be changed or adapted (e.g., by coloring, removing or enlarging parts of the depiction of the object). The terms “volume editing” and “segmentation” are also used in the prior art to describe such changes and adaptations. Volume editing therefore relates to adjustments, such as clipping, cropping and punching. Segmentation allows the classification of object structures such as, for example, anatomical structures of a body part that is depicted. Following segmentation, component parts of an object, for example, may be colored or removed. The term “direct volume editing” relates to the interactive editing or adjustment of the object depiction using virtual tools such as brushes, chisels, drills or knives. For example, the user may interactively change the image of the object as depicted on the screen by coloring or removing parts of the object using a mouse or other input device having haptic functionality or other functionality.

When processing the depicted object in this way, it may be insufficient to change the calculated pixels of the object image. Pixels may be recalculated instead. This provides that in the case of many such amendments (e.g., coloring, clipping), the volume rendering is performed again for each change. The amendment is made to the volume data that is used for the volume rendering. One method for this is proposed in Burger et al., “Direct Volume Editing,” Proceedings of IEEE Visualization, IEEE Transactions on Visualization and Computer Graphics, 2008. This method allows the depiction to be amended by directly editing a replicated volume.

### SUMMARY AND DESCRIPTION

Demand exists for flexible low-cost methods for amending the depiction of objects using ray casting, where memory requirements, processing requirements and broadband requirements, for example, are reduced in comparison with known methods.

The present embodiments may obviate one or more of the drawbacks or limitations in the related art. For example, the depiction of a three-dimensional volume (object) may be changed efficiently using ray casting.

For the purpose of changing (e.g., coloring, clipping) the depiction of a three-dimensional volume or object using ray casting, zones may be introduced and an assignment between affected zones and relevant changes may be provided. When dividing the volume into zones or cells, the zones or cells may correspond to spatial points of the volume, at which values are established for a variable that characterizes the object. The variable may be a density value, for example, determined or reconstructed by measurements, for example.

One zone may be established for each spatial point (e.g., exactly one zone is defined for each such spatial point or for each voxel).

The input of a change that is required with respect to the depiction may be effected, for example, using parameters. For example, the change is defined by a volume that is to be changed and a depiction change that is required with respect to the volume. This depiction change may be encoded using, for example, transfer functions, RGBA values, opacity values, or a combination thereof.

The volume to be changed may be composed of volume segments. The individual segments and the volume may be defined by parameters such as boundary points and radius, for example. After the change has been defined, the zones affected by the change are ascertained. The criterion may be a non-empty intersection between zone and volume to be changed. A change is classified as relevant to a zone if the zone is affected by the change. According to the present embodiments, an assignment is set up between affected zones and relevant changes. In this way, an information item is specified in each case (e.g., at least for affected zones), establishing a set of relevant changes for the zone concerned. This assignment may be realized by a list. This list assigns indices to zones, for example. The indices identify the relevant changes. Just one change or no changes may be relevant.

According to an embodiment, a maximal index and a minimal index are specified for each zone and are selected such that all relevant indices lie in the index range that is specified by the maximal index and the minimal index as limits. This provides that all relevant changes are included by a loop encompassing the indices. Ray casting is performed by simulated rays. For sampling points along the rays, a change is carried out if the sampling point is situated in an affected zone. For this purpose, the zone in which the sampling point is located may first be ascertained for a sampling point. The inclusion of changes in the calculation of the ray casting value of the sampling point is also restricted to changes that are assigned as relevant to the zone.

Ray casting becomes more efficient following the change to the depicted volume following the coloring or removal or layers. A limited set of changes is to be checked and (if applicable) taken into consideration for the calculation of sampled values. The set may include just one element or no elements. A considerable reduction in effort may be achieved.

According to one embodiment, a plurality of changes are performed, and all of the relevant changes are assigned for affected zones in each case. A first change is classified as no longer relevant to a zone if there is a second, later change that results in the first change no longer being visible in the depiction of the zone. The assignment between the change and the zone is cancelled for the change that is no longer relevant. This procedure allows for, for example, a scenario in which a subsequent change covers the zone completely, such that an earlier change no longer serves any purpose in the depiction.

The present embodiments also relate to a device for performing ray casting.

### BRIEF DESCRIPTION OF THE DRAWINGS

FIG. 1 shows the principle of ray casting methods;

FIG. 2 shows an exemplary input, using parameters, of a zone that is to be changed;

FIG. 3 shows exemplary strokes that are input using parameters;

FIG. 4 shows an exemplary segment that is defined by parameters;

FIG. 5 shows an exemplary volume that is divided into zones, and a depiction of the volume in the context of one embodiment of a rendering;

FIG. 6 shows a flow diagram of one embodiment of a method for efficiently changing a depiction of a three-dimensional volume using ray casting; and

FIG. 7 shows one embodiment of a hardware structure for efficiently changing a depiction of a three-dimensional volume using ray casting.

### DETAILED DESCRIPTION OF THE DRAWINGS

The following assumes that a representation has been obtained with respect to a volume or an object that is contained in the volume and is to be depicted. The representation includes values that characterize the object and are assigned to spatial points (e.g., voxels) of the volume. In the field of medical imaging, the values are initially provided in the form of tonal values that provide a measure of the density at the respective spatial point. In the context of medical applications, the tonal values correspond to density values of an examined tissue obtained by measurements. The measurements may be carried out using x-rays, nuclear spin tomography, or ultrasound, for example. The depiction of the object is effected by ray casting.

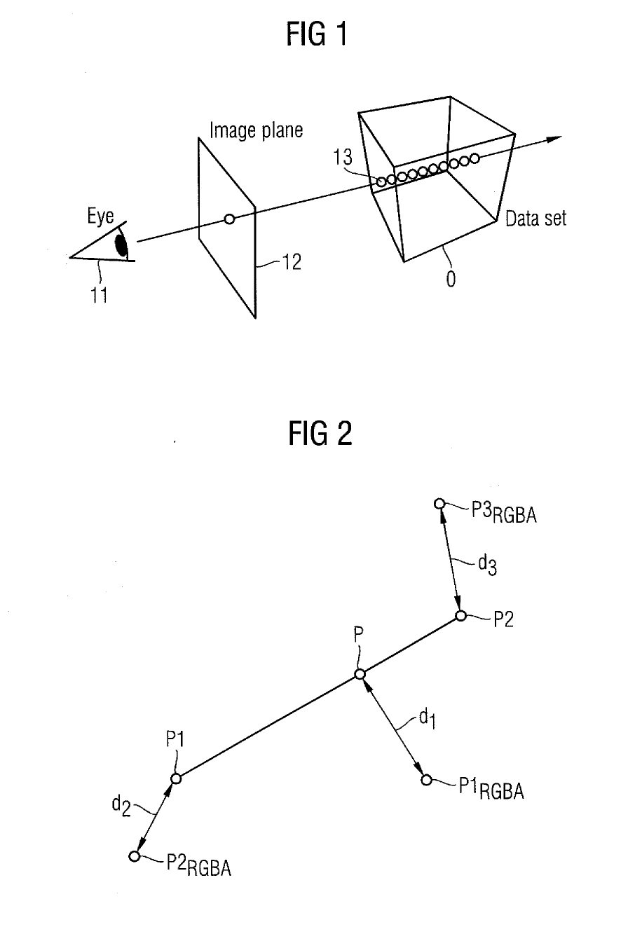

FIG. 1 shows the principle of ray casting methods as used in the prior art. Rays from a virtual eye 11 are transmitted through every pixel of a virtual image plane 12. Points of the rays are sampled within the volume or an object O at discrete positions (e.g., first position 13). A plurality of sampled values is combined to form a final pixel color.

The starting point for the combination of the object O includes RGBA values that are obtained with the aid of transfer functions.

The object that is depicted on a display screen may therefore be changed by an observer or user. A change is used to improve the depiction of properties of the object. For this purpose, coloring, changes in the light transparency, or thinning may be performed with respect to regions of the object, for example. Two information items are provided for this purpose: A) the region to be changed; and B) the type of change.

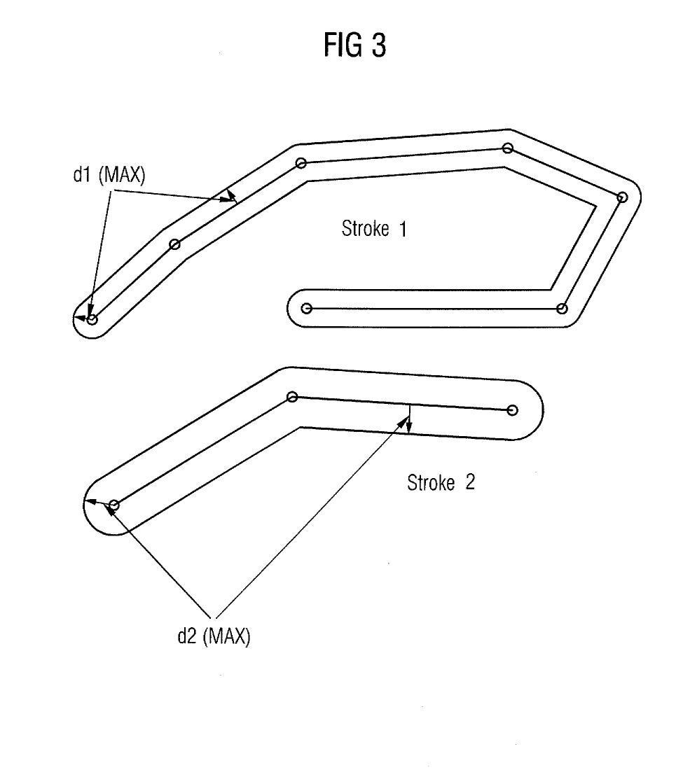

The region to be changed may be defined by parameters, some of which are input directly (e.g., using a computer mouse). FIGS. 2 and 3 show one possible approach.

The user describes a stroke for input to the depicted image using an input facility (e.g., the computer mouse). This stroke is registered (e.g., a position of the input facility is detected). Alternatively, the user clicks on a start point and an end point of a stroke and the clicks are captured. The start point and the end point of the stroke are assigned to the corresponding points on the surface of the object that is shown on the monitor. This provides that a stroke defines two points P1 and P2. The two points P1 and P2 may lie on the surface of the object. For as long as an input mode (e.g., corresponding to, for example, the depression of a mouse button) is maintained, a plurality of strokes may be made one after the other in order to modify corresponding zones of the object, where two consecutive points define a line segment in each case.

In this case, input information may be transformed immediately into a correspondingly changed depiction of the object by rendering. The concurrent adaptation of the image depiction on the monitor (e.g., using corresponding rendering of the object) has the advantage that the user immediately receives a visual feedback as a result of the input, and the visual feedback may be used for further inputs.

A distance criterion is used for the full specification of the region to be modified. The input correspondingly defines either a single point, a line segment (e.g., with boundary points P1 and P2) or a plurality of line segments. For points, at which RGBA values, as per the representation, are established, the minimal distance to the corresponding point set (e.g., point, segment or plurality of segments) is calculated. This is shown in FIG. 2 for the line segment that is defined by P1 and P2 (e.g., points P, where P=P1+u*(P2−P1), u from [0,1]). For the point P1_{RGBA}, the minimal distance d1 is the distance to the point P on the segment. In this case, the point P with the minimal distance may be determined from the condition that a straight line running through P, and P1_{RGBA} is perpendicular to the line segment that is defined by P1 and P2. Using the scalar product of vectors, this condition may be expressed as (P1_{RGBA}−P)*(P2−P1)=0. The formulation P=P1+u*(P2−P1) applied in this relationship with resolution by u gives uₘᵢₙ=(P1_{RGBA}−P1)*(P2−P1)/(P2−P1)**2. The distance d₁ is provided by the distance between the points P1_{RGBA} and P, where P is determined by uₘᵢₙ (P=P1+uₘᵢₙ*(P2−P1)). For the points P2_{RGBA} and P3_{RGBA}, the minimal distances d₂ and d₃ are the distances to the end points of the segment P1 and P2, respectively. For a plurality of segments, the minimal distance is determined by the minimum of the minimal distances to the individual segments. The result is the change in the depiction of the object in the zone of the segments. This is illustrated for two scenarios in FIG. 3. The upper part of FIG. 3 shows coloring of a zone using six segment lines, and the lower part of FIG. 3 shows coloring that includes two segment lines. Different maximal distances (d1(MAX) and d2(MAX)) are used in this case, resulting in different widths of the colored zones. This width may be adapted according to current requirements. The depth of the zone may also be varied depending on the width. For example, the distance criterion may be used to define the ray casting rays, for which RGBA value adaptation takes place. The length of the ray (e.g., from the surface), for which the adaptation applies, may be defined according to another criterion. This may be a distance criterion. An adaptation may be performed until a tissue change occurs (e.g., to adapt RGBA values for a tissue class along the ray). This is useful for removal of a tissue layer at specified locations.

The criterion for the change or modification of the RGBA value at a point P_{RGBA} is that the minimal distance is smaller than a maximal distance d(MAX).

A change in the depiction may be encoded using RGBA values. Depending on a change in the RGBA value, a region (e.g., composed of a plurality of part segments) is colored, made impermeable to light or removed. In the case of coloring, an RGB value that is used to modify the relevant RGBA value (e.g., by addition, subtraction, multiplication or substitution) may, for example, be specified. In one embodiment, a specific transfer function for the region may be specified.

It is not necessary to perform a uniform change of the whole region in this case. For example, a “fuzzy brush” may be used. In other words, the effect of a gradual transition is created in the vicinity of the region boundary. Such effects may be achieved if the change that is performed within a region is not performed uniformly.

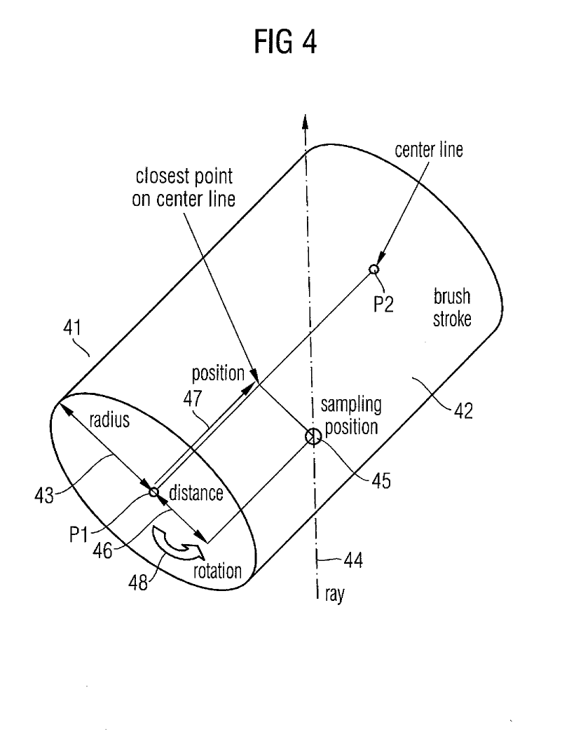

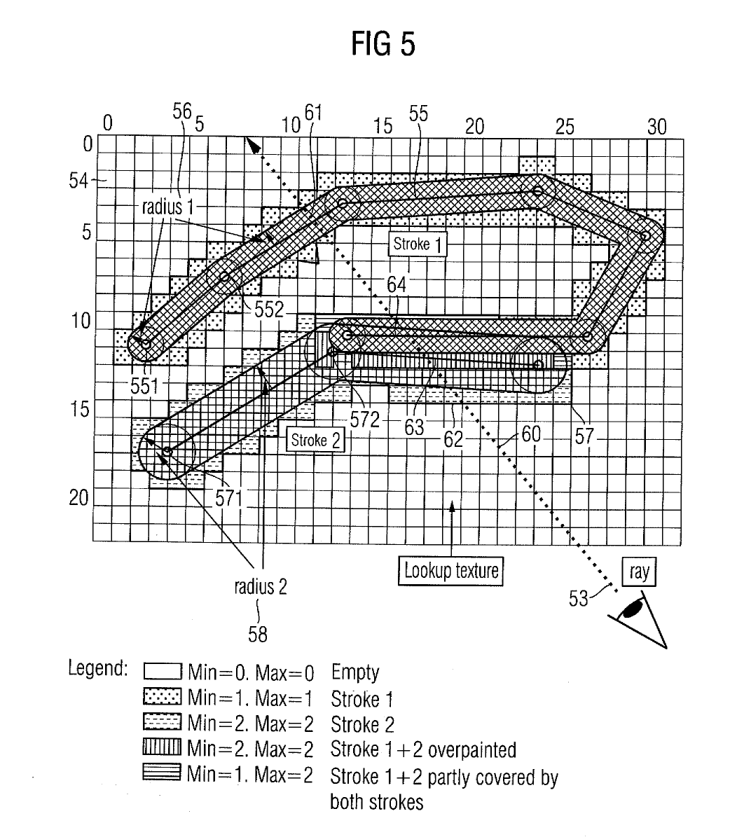

FIG. 4 shows a segment 41 that is part of a region that has been changed by a brush stroke. The segment 41 is defined by two points P1 and P2. The two points P1 and P2 specify a central section 42 that determines the segment length. A radius 43 defines the overall extent of the segment as points with a perpendicular distance to the central section 42 being less than or equal to the radius 43. Rays through this segment 41 are simulated during the rendering. A ray 44 is marked by way of example. RGBA values are calculated along the ray 44 and combined to form a pixel in the context of ray casting. A position 45 for this calculation is marked. The calculation of the RGBA value for this position is changed by the brush stroke. The change depends on parameters that have been predefined for the brush stroke (e.g., RGBA values, transfer function). The change may also depend on the position 45 (e.g., when using a “fuzzy brush”). The points within the region may be defined unambiguously using three parameters (e.g., the perpendicular distance 46 to the central section 42, the position 47 of the perpendicular projection on the central section 42, and a suitably defined angle 48). The change (e.g., RGBA value, transfer function) may be a function of the three parameters (e.g., perpendicular distance 46, position 47 and angle 48), for example, in order to achieve a smoother transition at the region boundary zone.

Since the position 45 is inside the changed region, a change is performed during the ray casting. When simulating the rays for each of the sampling points, whether and (if applicable) which changes are to be carried out may be checked. This procedure involves considerable effort.

The present embodiments make the method more efficient. The volume to be depicted is divided into zones (e.g., three-dimensional zones). In this case, one zone is defined for each spatial point or voxel that is used for the representation of the object. The zones that are affected by a change are labeled or indexed when the change is input or defined. In one embodiment, if there is a plurality of changes, the label references the changes that are relevant to the zone. A change is relevant to a zone if at least one part of the zone overlaps the region of the change. For the sake of simplicity, it is assumed in the following that changes are given an index number in each case, and the label is provided by an index list. A minimal (e.g., first) and a maximal (e.g., last) index are assigned to a zone in each case. The changes in the index range that is defined by the minimal index and the maximal index are considered to be relevant to the corresponding zone. Zones having only one relevant change are assigned the corresponding index, and zones without a relevant change are assigned the index zero.

The procedure is illustrated in greater detail below in two dimensions with reference to FIG. 5. The embodiment shown in FIG. 5 is a simplification in comparison with the usual scenario of three dimensions.

FIG. 5 shows a grid that defines zones or cells. There are, for example, 32*23=736 cells, where horizontal and vertical indices are provided for the purpose of identifying the cells (e.g., horizontal 0-31, vertical 0-22). The cell 54 is shown by way of example. The cell 54 is assigned the index tuple (0,2). Also shown is a first region or first brush stroke 55 (e.g., a region). The region 55 is composed of individual segments (e.g., six segments). The individual segments are each defined by two points and a radius. By way of example, the points for one segment are denoted by the reference signs 551 and 552. The radius has the reference sign 56. The first region 55 is assigned the region index 1 (e.g., stroke 1). Also shown is a second, subsequent stroke 57 that is composed of two segments and corresponds to a region having a region index 2. Again, two points 571 and 572 and a radius 58 are shown by way of example. Five different scenarios are distinguished for the individual zones, where one exemplary zone is designated in each case for the scenarios. The zone has been selected such that the ray 53 indicated in FIG. 5 passes through the corresponding zone. There are zones such as, for example, zone 60 (e.g., index tuple (16,20)) that do not have any intersections with the strokes 1 and 2. The zones are left white in FIG. 5. Such zones are assigned the index 0 as a maximal and minimal region index in each case. There are also zones (e.g., partially gray) that only have an intersection with the stroke 1. Such zones are assigned the index 1 for the stroke 1 as a minimal and maximal region index. For example, the zone or cell having the index tuple (11,4) is denoted by the reference sign 61. There are also zones that only have an intersection with the second stroke. Such a zone is identified by the reference sign 62 (index tuple (19,14)), for example. For these zones, the minimum and maximum of the region index is equal to 2 (e.g., only stroke 2 will be taken into consideration). The fourth category includes zones that have an intersection with both the first stroke and the second stroke, where the second stroke covers the zone completely. In these exemplary embodiments, it is assumed that the latest or last stroke in each case fully specifies the change to the region. This provides that earlier strokes no longer serve any purpose in the depiction. In the case of FIG. 5, the second stroke is more relevant to zones that do have an intersection with the first stroke but are completely covered by the second stroke. Such a zone is shown by the reference sign 63 (index tuple (18,12)). This zone is likewise assigned the value of 2 as minimum and maximum of the indices (e.g., the change performed by stroke 2 is taken into consideration during the rendering). An update of the indices takes place when the stroke is performed. This is because prior to the application of the stroke 2, the index list for the zone 63 is specified as minimum and maximum 1 because the intersection with the first stroke is not empty. When the second stroke is performed, the stroke 1 is considered to become irrelevant due to the complete coverage. The stroke 1 is no longer taken into consideration in the index list for the corresponding zone. Complete coverage by a later stroke does not necessarily provide that an earlier stroke becomes irrelevant. This may apply in the case of a “fuzzy brush,” for example (e.g., when stroke contours are blurred and become less distinct at the boundaries). When using such fuzzy strokes, it may be taken into account that two or more strokes are involved when boundaries overlap (e.g., an earlier stroke still shines through at the boundary of a later stroke). This more complex scenario is not assumed in the case of the explanation relating to FIG. 5. FIG. 5 shows a fifth category of zones (e.g., zone 64, index tuple (16,10)), for which both strokes are relevant. In this case, the intersection with both strokes is not empty, and the second stroke does not cover the zone completely. In this case, the index minimum is 1, and the index maximum is 2 for the purpose of region assignment (e.g., both strokes (regions) are taken into consideration for the calculation).

With reference to the zones 60 to 64, each of which is traversed by the ray 53, the following describes how the rendering for sampling points in the corresponding zones changes, as a result of the method of the present embodiments, in comparison with conventional rendering. For a sampling point in the zone 60, the corresponding zone (e.g., zone 60) is identified for the sampling point, and the associated indices are found to be 0 using an index table. The identification of the relevant zone during the rendering is simple if the zones are assigned to the voxels. This is because the relevant voxel values are used for the calculation of the RGBA value of the sampling point. Identification may be done by an assignment between a zone and one or more voxels. The found index 0 indicates that the rendering may be performed without taking any changes into account. With regard to the sampling point in the zone 62, index minimum and maximum may be 2 in each case, and therefore, the changes (e.g., transfer functions) associated with the stroke 2 are taken into account for the corresponding sampled value. In the case of the zone 63, the same result may be obtained (e.g., the zone 2 is taken into account again). In the case of a sampled value in the zone 64, it may be ascertained from the index table that strokes 1 and 2 are relevant. Whether the sampling point is in the region of the stroke 2 may first be determined. If this is the case, a change corresponding to the stroke 2 is performed. Otherwise, a check may ascertain whether the sampling point falls in the region of stroke 1, and the corresponding change is carried out if the sampling point falls in the region of stroke 1. This may be extended over a plurality of strokes (e.g., in the case of a string of strokes corresponding to the sequence, in which the strokes were made (chronological sequence, starting from the highest index to the lowest index, whether the sampling point falls in the region may be queried; if so, the corresponding change would be performed, and the query would be terminated). There is also the case of zone 61. The minimum and the maximum are both equal to 1 for the zone 61. Zone 61 is partially covered by the region of the stroke 1. In this case, whether the sampling point falls in the region of the stroke 1 may be checked, and the change is performed if so.

Strokes and/or changes may be taken into consideration more efficiently in this way. The processing effort may be significantly reduced in the case of a plurality of strokes, for example, since a simple query may establish whether a sampling point changes and, if appropriate, which changes are to be taken into consideration.

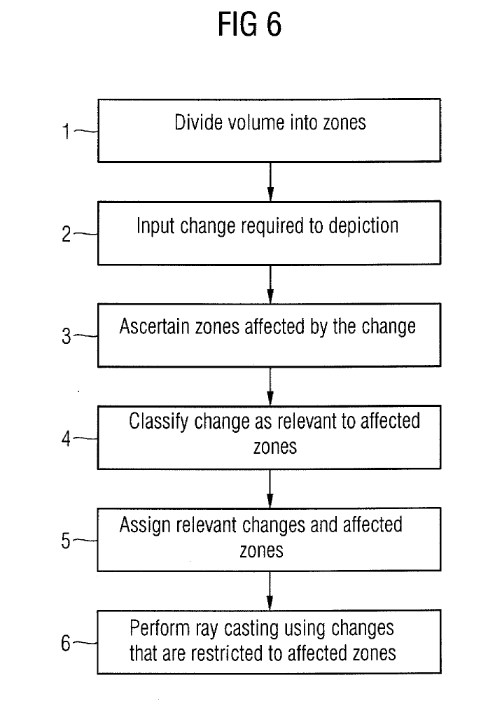

FIG. 6 shows the principle of the present embodiments in summary. The volume is divided into zones in act 1. Act 2 includes inputting a change that is to be performed (e.g., manually using an input device). In act 3, the zones affected by the change are ascertained. A change is specifically classified as relevant to a zone if the zone is affected by this change (act 4). An assignment of relevant changes and affected zones is generated on this basis (act 5). This assignment is used during the ray casting, such that new calculations are only performed for affected zones (act 6), thereby significantly reducing the calculation effort.

The present embodiments may be implemented in various forms of hardware (e.g., a processor and/or a non-transitory computer-readable medium), software, firmware, special-purpose processors or a combination thereof An implementation on a graphics processing unit (GPU) using open graphics language (OpenGL) and the OpenGL Shading Language is provided.

In one embodiment, the present embodiments may be implemented in software as an application program. The application program may be uploaded to and executed on a machine having any suitable architecture.

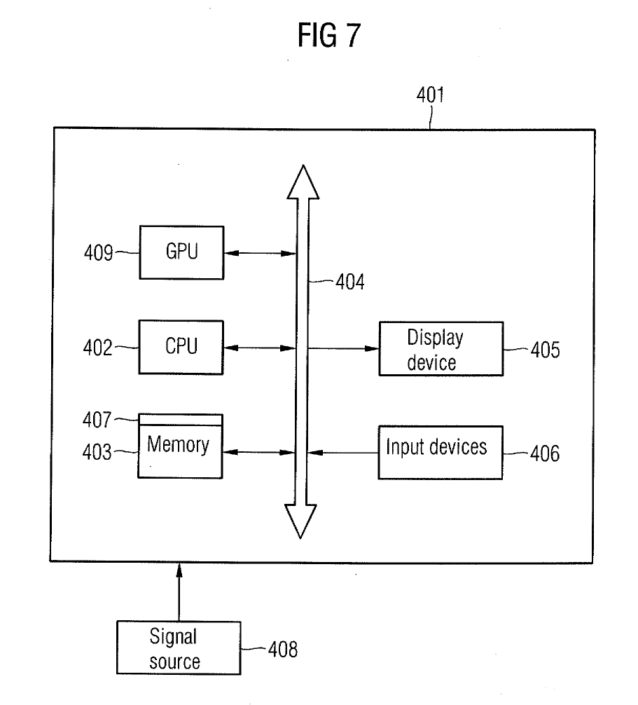

With reference to FIG. 7, in one embodiment, a computer system 401 may include a central processing unit (CPU) 402, a memory 403, and an input/output (I/O) interface 404 for GPU-based ray casting. The computer system 401 may be connected via the I/O interface 404 to a display device 405 and various input devices 106 such as, for example, a mouse or a keyboard. The additional circuits may include circuits such as, for example, cache, power supply, clock circuits and a communication bus. The memory 403 may include random access memory (RAM), read-only memory (ROM), a floppy disk drive, a tape drive, other hardware or a combination thereof. The present embodiments may be implemented as a program routine 407 that is stored in the memory 403 and executed by the CPU 402 in order to process the signal from the signal source 408. The computer system 401 further includes a graphics processing unit (GPU) 409 for processing graphics instructions (e.g., for processing the signal source 408 that includes image data). The computer system 401 is a general multipurpose computer system that becomes a special-purpose computer system when the computer system 401 executes the program 407 of the present embodiments.

The computer platform 401 also contains an operating system and a microinstruction code in the non-transitory memory 403. The various methods and functions described herein may be part of the microinstruction code, part of the application program, or a combination of the part of the microinstruction code and the part of the application program that is executed by the operating system. In one embodiment, various other peripheral devices (e.g., an additional data storage device and a printing device) may be attached to the computer platform.

Since some of the individual system components and method acts illustrated in the appended figures may be implemented in software, the actual connections between the system components (or between the process acts) may vary depending on the way, in which the present embodiments are programmed.

The present embodiments are not restricted to the applications illustrated in the exemplary embodiment. For example, the method may be used for virtual depictions in fields that are different to that of medical technology. Examples include the visualization of products in the context of business and trade, and computer games.

While the present invention has been described above by reference to various embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description.

1. A method for efficiently changing a depiction of a three-dimensional volume using ray casting, the method comprising:
dividing the three-dimensional volume into zones;
inputting a change to the depiction;
ascertaining the zones that are affected by the change;
classifying the change as relevant to a zone when the zone is affected by the change;
effecting an assignment between affected zones and relevant changes; and
performing ray casting using simulated rays,
wherein the change is only carried out for sampling points along the rays when the sampling point lies in one of the affected zones.

2. The method as claimed in claim 1, further comprising categorizing a zone as an affected zone when the zone has a non-empty intersection with the three-dimensional volume to be changed.

3. The method as claimed in claim 1, wherein a plurality of changes are performed,
wherein all relevant changes are assigned for affected zones,
wherein the method further comprises:
classifying a first change as no longer relevant to a zone when there is a second, later change that results in the first change in the depiction of the zone being no longer visible; and
cancelling the assignment between the first change and the zone.

4. The method as claimed in claim 3, wherein the assignment comprises a list that assigns indices to zones,
wherein the indices identify the relevant changes, and
wherein a maximal index and a minimal index are specified for each zone and are selected such that all indices of relevant changes lie in the index range that is specified by the maximal index and the minimal index as limits.

5. The method as claimed in claim 3, further comprising:
defining a volume that is to be changed by the change;
classifying a first change as no longer relevant to a zone when there is a second, later change having a volume that contains the zone completely; and
cancelling the assignment between the first change and the zone.

6. The method as claimed in claim 1, wherein an information item is specified at least for each of the affected zones, the information item establishing a set of relevant changes for the zone.

7. The method as claimed in claim 6, further comprising storing the zone-specific information items in a list.

8. The method as claimed in claim 1, further comprising establishing, at spatial points of the three-dimensional volume, values for a variable that characterizes an object,
wherein one of the zones is specified for each of the spatial points.

9. The method as claimed in claim 1, wherein the change is defined by a volume that is to be changed and the depiction change that is required for the volume.

10. The method as claimed in claim 1, wherein the three-dimensional volume that is to be changed is inputtable using parameters.

11. The method as claimed in claim 1, wherein the depiction change relates to a color value, an opacity value, or the color value and the opacity value.

12. The method as claimed in claim 2, wherein a plurality of changes are performed,
wherein all relevant changes are assigned for affected zones,
wherein the method further comprises:
classifying a first change as no longer relevant to a zone when there is a second, later change that results in the first change in the depiction of the zone being no longer visible; and
cancelling the assignment between the first change and the zone.

13. The method as claimed in claim 4, further comprising:
defining a volume that is to be changed by the change;
classifying a first change as no longer relevant to a zone when there is a second, later change having a volume that contains the zone completely; and
cancelling the assignment between the first change and the zone.

14. The method as claimed in claim 2, wherein an information item is specified at least for each of the affected zones, the information item establishing a set of relevant changes for the zone.

15. The method as claimed in claim 2, further comprising establishing, at spatial points of the three-dimensional volume, values for a variable that characterizes an object,
wherein one of the zones is specified for each of the spatial points.

16. The method as claimed in claim 2, wherein the change is defined by a volume that is to be changed and the depiction change that is required for the volume.

17. The method as claimed in claim 2, wherein the three-dimensional volume that is to be changed is inputtable using parameters.

18. A device for efficiently changing a depiction of a three-dimensional volume using ray casting, the device comprising:
a processor configured to:
divide the three-dimensional volume into zones;
input a change to the depiction;
ascertain the zones that are affected by the change;
classify the change as relevant to a zone when the zone is affected by the change;
effect an assignment between the affected zones and the relevant changes; and
perform ray casting using simulated rays,
wherein a change is only carried out for sampling points along the rays when the sampling point lies in one of the affected zone.

19. The device as claimed in claim 12, wherein the processor comprises functional modules configured to divide, input, ascertain, classify, effect, and perform, respectively.

20. In a non-transitory computer-readable storage medium that stores instructions executable by one or more processors to efficiently change a depiction of a three-dimensional volume using ray casting, the instructions comprising:
dividing the three-dimensional volume into zones;
inputting a change to the depiction;
ascertaining the zones that are affected by the change;
classifying the change as relevant to a zone when the zone is affected by the change;
effecting an assignment between affected zones and relevant changes; and
performing ray casting using simulated rays,
wherein the change is only carried out for sampling points along the rays when the sampling point lies in one of the affected zones.
